(19) United States
(12) Patent Application Publication
(10) Pub. No.: US 2022/0416278 A1
(43) Pub. Date: Dec. 29, 2022

(54) OPERATING SYSTEMS AND METHODS OF USING A PROPORTIONAL CONTROL VALVE IN A FUEL CELL SYSTEM

(71) Applicants: CUMMINS INC., Columbus, IN (US); HYDROGENICS CORPORATION, Mississauga (CA)

(72) Inventors: Richard J. ANCIMER, Toronto (CA); Eero TEENE, Hamilton (CA); Paolo FORTE, Maple (CA); Sumit TRIPATHI, Columbus, IN (US)

(21) Appl. No.: 17/837,721

(22) Filed: Jun. 10, 2022

Related U.S. Application Data
(60) Provisional application No. 63/215,072, filed on Jun. 25, 2021.

(51) Int. Cl. H01M 8/04746; H01M 8/0438

(52) U.S. Cl. CPC H01M 8/04783; H01M 8/04395; H01M 8/04388

(57) ABSTRACT

The present disclosure relates to systems and methods of using a proportional control valve in a fuel cell stack system. The fuel cell stack system, may comprise a fuel cell stack including an anode with an anode inlet and an anode outlet, and a cathode with a cathode inlet and a cathode outlet, and a control valve, which controls the flow of a fuel into the anode. The flow of fuel may be based on a pressure differential measured across any two of the anode inlet, the anode outlet, the cathode inlet, and the cathode outlet.

### CROSS-REFERENCE TO RELATED APPLICATIONS

This nonprovisional application claims the benefit and priority, under 35 U.S.C. § 119(e) and any other applicable laws or statutes, to U.S. Provisional Patent Application Ser. No. 63/215,072 filed on Jun. 25, 2021, the entire disclosure of which is hereby expressly incorporated herein by reference.

### TECHNICAL FIELD

The present disclosure relates to systems and methods of using a proportional control valve in a fuel cell or a fuel cell stack system.

### BACKGROUND

Vehicles and/or powertrains use fuel cells or fuel cell stacks for their power needs. A fuel cell and/or fuel cell stack may include, but is not limited to a phosphoric acid fuel cell (PAFC), a molten carbonate fuel cell (MCFC), a proton exchange membrane fuel cell, also called a polymer exchange membrane fuel cell (PEMFC), or a solid oxide fuel cell (SOFC).

A fuel cell or fuel cell stack system may include a plurality of fuel cells or fuel cell stacks. A fuel cell or fuel cell stack system may generate electricity in the form of direct current (DC) from electrochemical reactions that take place in the fuel cell or fuel cell stack. A fuel processor converts fuel into a form usable by the fuel cell or fuel cell stack. If the fuel cell or fuel cell stack system is powered by a hydrogen-rich, conventional fuel, such as methanol, gasoline, diesel, or gasified coal, a reformer may convert hydrocarbons into a gas mixture of hydrogen and carbon compounds, or reformate. The reformate may then be converted to carbon dioxide, purified, and recirculated back into the fuel cell or fuel cell stack.

Fuel, such as hydrogen or a hydrocarbon, is channeled through field flow plates to an anode on one side of the fuel cell or fuel cell stack, while oxygen from the air is channeled to a cathode on the other side of the fuel cell or fuel cell stack. At the anode, a catalyst, such as a platinum catalyst, causes the hydrogen to split into positive hydrogen ions (protons) and negatively charged electrons. In the case of a polymer exchange membrane fuel cell (PEMFC), the polymer electrolyte membrane (PEM) permits the positively charged ions to flow through the PEM to the cathode. The negatively charged electrons are directed along an external loop to the cathode, creating an electrical circuit and/or an electrical current. At the cathode, the electrons and positively charged hydrogen ions combine with oxygen to form water, which flows out of the fuel cell or fuel cell stack.

The pressure differential between the anode and cathode needs to be above a minimum value to prevent gas cross-over between the anode and cathode streams, and/or to avoid mechanical stresses on the membrane electrode assembly (MEA) or on the electrolyte of the fuel cell. A mechanical regulator is typically used to control the flow of fresh fuel to the anode, and to maintain the pressure differential between the anode and the cathode. However, because of its mechanical design, the mechanical regulator offers minimal flexibility in varying a target pressure differential between the anode and the cathode. The rigidity of the mechanical design of the mechanical regulator presents certain challenges. For example, the mechanical regulator may allow for a change in pressure differential (e.g., droop) as the flow of fuel varies through the valve(s) of the mechanical regulator. Furthermore, the mechanical regulator must account for sensitivity to the inverse sympathetic ratio (ISR) which characterizes sensitivity of the fuel cell or fuel cell stack system to downstream pressure.

To overcome the challenges described above, a proportional control valve may be used to control the flow of fresh fuel to the anode, to monitor the pressure differential between the anode and cathode in a fuel cell or fuel cell stack, and/or to maintain the pressure differential between the anode and cathode in a fuel cell or fuel cell stack. The present disclosure provides systems and methods of using the proportional control valve to overcome current challenges known in the art relevant to the usage of the proportional control valve in the fuel cell or fuel cell stack system.

### SUMMARY

Embodiments of the present disclosure are included to meet these and other needs.

In one aspect of the present disclosure, described herein, a fuel cell stack system includes a fuel cell stack and a proportional control valve. The fuel cell stack includes an anode with an anode inlet and an anode outlet and a cathode with a cathode inlet and a cathode outlet. The proportional control valve controls the flow of a fuel into the anode based on a pressure differential measured across any two of the anode inlet, the anode outlet, the cathode inlet, and the cathode outlet.

In the first aspect, the pressure differential may be measured by a first single point pressure sensor positioned at the anode inlet or the anode outlet and a second single point pressure sensor positioned at the cathode inlet or the cathode outlet. In this aspect, the measurements made by the first single point pressure sensor at the anode inlet or anode outlet and the second single point pressure sensor at the cathode inlet or cathode outlet may have a combined standard error of less than about 25% of a target bias pressure. The target bias pressure may be based on operating conditions of the fuel cell stack. Alternatively or additionally, the first single point pressure sensor at the anode inlet or anode outlet and the second single point pressure sensor at the cathode inlet or cathode outlet may be subject to a calibration. The calibration may be communicated to a controller of the proportional control valve.

Alternatively or additionally, a controller of the proportional control valve may target a bias pressure with an offset. The offset may be calibrated based on a known uncertainty in measurements made by the first and second single point pressure sensors, and on a minimum target bias pressure. The controller of the proportional control valve may include an inner control loop and an outer control loop. The inner control loop may use a force balance or inverse sympathetic ratio (ISR) compensation method. The inner control loop may be an open loop based on pressure downstream of the proportional control valve and may be estimated using a target flow rate. The inner control loop may compensate for a fuel supply temperature measurement by using a physical or virtual sensor.

In the first aspect, the first pressure differential may be measure by a pressure differential sensor across the anode and the cathode.

In the first aspect, the proportional control valve may be configured to operate in combination with an ejector. The proportional control valve may include at least one controller that corrects for non-linear dynamics when a primary nozzle of the ejector is choked or not choked.

In a second aspect of the present disclosure, described herein, a method of implementing and/or controlling a proportional control valve in a fuel cell or fuel cell stack includes the steps of measuring a pressure differential across any two of an anode inlet, and anode outlet, a cathode inlet, and a cathode outlet of the fuel cell or fuel cell stack, flowing a fuel through the proportional control valve based on the pressure differential, and controlling the proportional control valve operation by one or more controllers. An anode includes the anode inlet and the anode outlet. A cathode includes the cathode inlet and the cathode outlet. The step of measuring the pressure differential includes using a first single point pressure sensor at the anode inlet or the anode outlet and a second single point pressure sensor at the cathode inlet or the cathode outlet.

In the second aspect, the first and second single point pressure sensors may have a combined standard error less than about 25% of a target bias pressure.

In the second aspect, the method may further include calibrating offline the first single point pressure sensor at the anode inlet or the anode outlet and the second single point pressure sensor at the cathode inlet or the cathode outlet to determine a calibration value and communicating the calibration value to the one or more controllers of the proportional control valve.

In the second aspect, the method may further include introducing a disturbance using the proportional control valve based on operating condition of the fuel cell or fuel cell stack.

In the second aspect, the method may further include evaluating the first single point pressure sensor and the second single point pressure sensor relative to each other and introducing a correction into the proportional control valve if required.

In the second aspect, controlling the proportional control valve may further include implementing an inner control loop. The inner control loop may be an open loop based on pressure downstream of the proportional control valve. The method may further including implementing the inner control loop by estimating a target fuel flow rate. The inner control loop may use a force balance or inverse sympathetic ratio (ISR) compensation method. Alternatively or additionally, the inner control loop may compensate for a fuel supply temperature measurement by using a physical or virtual sensor.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1A is an illustration of a fuel cell system including one or more fuel cell stacks connected to a balance of plant.

FIG. 1B is an illustration of the fuel cell system including one or more fuel cell modules.

FIG. 1C is an illustration of components of a fuel cell in the fuel cell stack.

FIG. 2 is a graph showing the operating curves of a system comprising a fuel cell or fuel cell stack.

FIG. 3 is a schematic showing a mechanical regulator used along with a venturi or ejector in a fuel cell stack system.

FIG. 4 is a schematic showing a proportional control valve used along with a venturi or ejector in a fuel cell stack system.

FIG. 5 is a schematic showing inner and outer control loops used to monitor, measure, and/or control the anode pressure and primary flow.

### DETAILED DESCRIPTION

The present disclosure relates to operating systems and methods of using a proportional control valve for controlling the flow of fresh fuel to an anode of a fuel cell or fuel cell stack in a fuel cell stack system. The present disclosure relates to systems and methods for maintaining or monitoring a pressure differential between the anode and a cathode of the fuel cell or fuel cell stack. More specifically, the present disclosure relates to overcoming challenges in a fuel management system of the fuel cell system power module when using a proportional control valve.

The fuel cell system power module may comprise a fuel management system that controls, manages, implements, or determines the flow of a primary fuel (e.g., hydrogen) as a fuel stream to the anode. Fuel flow control may occur through an anode inlet at a rate that matches, exceeds, or is less than a fuel consumption rate of the fuel cell or fuel cell stack. The fuel flow control may depend on a recirculation rate of a fuel stream exhaust from a fuel cell or fuel cell stack outlet back to the anode inlet. The fuel flow control may depend on the operation of the fuel cell or fuel cell stack at a target pressure. The fuel flow control may depend on the maintenance of a pressure differential between the anode and cathode streams within a specified target range.

A minimum excess fuel target for a system may be specified as a minimum level of an excess fuel target required by the fuel cell or fuel cell stack based on the operating conditions of the fuel cell or fuel cell stack. A fuel cell or fuel cell stack may have an excess fuel level higher than the minimum excess fuel target, but achieving that higher level may result in a high parasitic load on the fuel cell or fuel cell stack. For example, the excess fuel level higher than the minimum excess fuel target may be achieved by maintaining high fuel flow rates at the anode, which may lead to pressure loss in the fuel cell or fuel cell stack.

A blower and/or a pump (e.g., a recirculation pump) may function at a capacity proportional to the pressure loss in the fuel cell or fuel cell stack. The blower and/or the pump may also function at a capacity proportional to the volumetric flow rate through the blower and/or the pump. A blower and/or a pump may use additional power to compensate for the pressure loss. Use of additional power by the blower and/or the pump may result in a high parasitic load on the fuel cell or fuel cell stack.

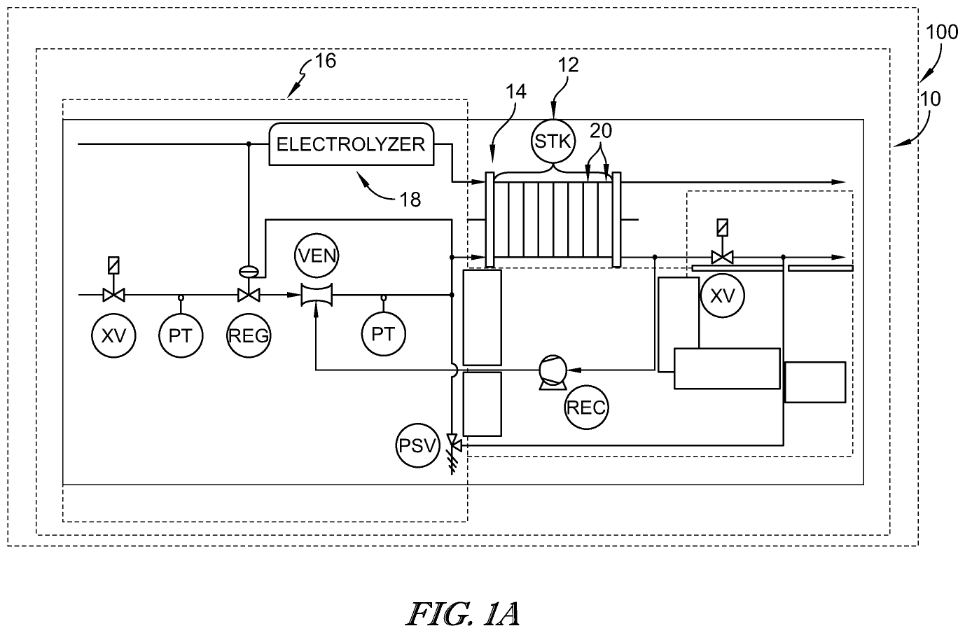

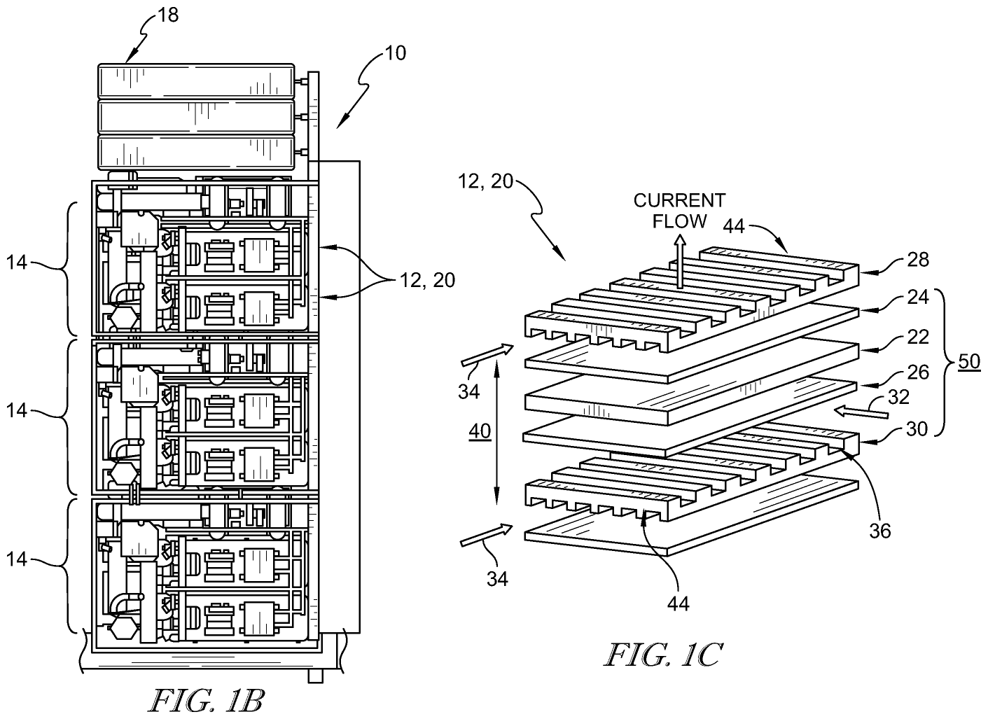

As shown in FIG. 1A, fuel cell systems or fuel cell stack systems 10 often include one or more fuel cell stacks 12 or fuel cell modules 14 connected to a balance of plant (BOP) 16, including various components, to create, generate, and/or distribute electrical power for meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 connected together in series and/or in parallel. The fuel cell system 10 may include one or more fuel cell modules 14 as shown in FIGS. 1A and 1B. Each fuel cell module 14 may include a plurality of fuel cell stacks 12 and/or a plurality of fuel cells 20.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and a gas diffusion layer (GDL) 24, 26 on either or both sides of the membrane electrode assembly (MEA) 22 (see FIG. 1C). The fuel cell 20 further includes a bipolar plate (BPP) 28, 30 on the external side of each gas diffusion layers (GDL) 24, 26. The above mentioned components, 22, 24, 26, 30 comprise a single repeating unit 50.

The bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plate (BPP) 28, 30 can uniformly distribute reactants 32, 34 to an active area 40 of each fuel cell 20 through oxidant flow fields 42 and/or fuel flow fields 44. The active area 40, where the electrochemical reactions occur to generate electrical power produced by the fuel cell 20, is centered within the gas diffusion layer (GDL) 24, 26 and the bipolar plate (BPP) 28, 30 at the membrane electrode assembly (MEA) 22. The bipolar plate (BPP) 28, 30 are compressed together to isolate and/or seal one or more reactants 32 within their respective pathways, channels, and/or flow fields 42, 44 to maintain electrical conductivity, which is required for robust during fuel cell 20 operation.

The fuel cell system 10 described herein, may be used in stationary and/or immovable power system, such as industrial applications and power generation plants. The fuel cell system 10 may also be implemented in conjunction with electrolyzers 18 and/or other electrolysis system 18. In one embodiment, the fuel cell system 10 is connected and/or attached in series or parallel to an electrolysis system 18, such as one or more electrolyzers 18 in the BOP 16.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy duty vehicle.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck or a mine haul truck.

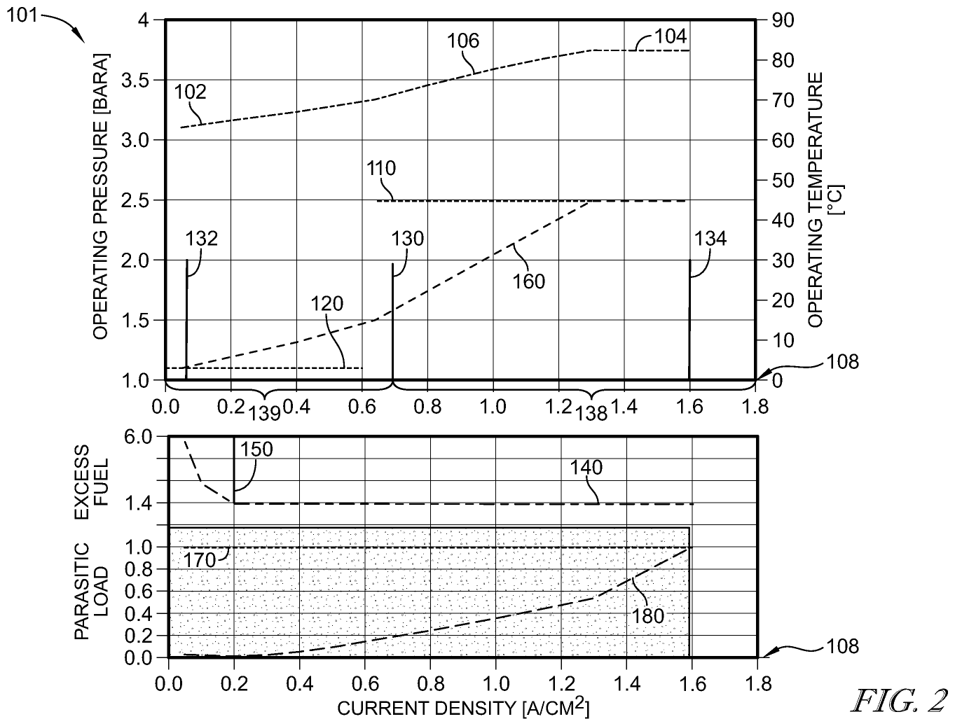

One embodiment of operating characteristics of the fuel cell system 10 comprising a fuel cell 20 or fuel cell stack 12 is illustrated in graph 101 in FIG. 2. Operating pressures and associated operating temperatures are shown as a function of current density 108. The fuel cell 20 or fuel cell stack 12 may be required to operate within a pressure range known as anode inlet manifold pressure (P_{AIM}) measured at the anode inlet manifold 213.

Highest anode inlet manifold pressure (P_{AIM_HI}) of the fuel cell 20 or fuel cell stack 12 is denoted by 110. Lowest anode inlet manifold pressure (P_{AIM_LO}) of a fuel cell 20 or fuel cell stack 12 is denoted by 120. The range 160 between the highest anode inlet manifold pressure (P_{AIM_HI}) 110 and the lowest anode inlet manifold pressure (P_{AIM_LO}) 120 indicates a target anode inlet manifold pressure range or operating pressure. A target temperature of the fuel cell system 10 may range from a low fuel supply operating temperature (T_{CV_LO}) 102 to a high fuel supply operating temperature (T_{CV_HI}) 104.

It is critical to operate the fuel cell 20 or fuel cell stack 12 at a pressure that ranges from about or approximately the highest anode inlet manifold pressure (P_{AIM_HI}) 110 to about or approximately the lowest anode inlet manifold pressure (P_{AIM_LO}) 120 when the fuel cell 20 or fuel cell stack 12 is operating above a critical current density (i__{LO_CR}) 130. In some embodiments, the critical current density (i__{LO_CR}) 130 may be at about 0.7 A/cm². In other embodiments, the critical current density (i__{LO_CR}) 130 may be at about 0.6 A/cm². In some further embodiments, the critical current density (i__{LO_CR}) 130 may be higher or lower than 0.7 A/cm², such as ranging from about 0.5 A/cm² to about 0.9 A/cm², including every current density 108 or range of current density 108 comprised therein.

The fuel cell 20 or fuel cell stack 12 may operate at a high current density 138, which may be higher than the critical current density (i__{LO_CR}) 130. The high current density 138 may range from about 1.3 A/cm² to about 2.0 A/cm², or about 1.3 A/cm² to about 1.6 A/cm², or about 1.0 A/cm² to about 1.6 A/cm², including every current density 108 or range of current density 108 comprised therein.

In some embodiments, operating the fuel cell 20 or fuel cell stack 12 at such high current density 138 (e.g., at about 1.6 A/cm²) with result in operating the fuel cell 20 or fuel cell stack 12 at pressures and temperatures different from optimal target operating pressures and operating temperatures. Operating the fuel cell 20 or fuel cell stack 12 at pressures and temperatures different from the optimal target operating pressures and operating temperatures may lower the efficiency of the fuel cell 20 or fuel cell stack 12. Such operation may also result in damage to the fuel cell 20 or fuel cell stack 12 because of MEA 22 degradation (e.g., due to starvation, flooding and/or relative humidity effects). In some embodiments, there may be more flexibility in the fuel cell 20 or fuel cell stack 12 operating pressure and operating temperature when the fuel cell 20 or fuel cell stack 12 is operating below the critical current density (i__{LO_CR}) 130. The present operating system comprising the fuel cell or fuel cell stack can operate at a minimum current density (i_{MIN}) 132 and a maximum current density (i_{MAX}) 134.

In one embodiment, the fuel cell system 10 comprising the fuel cell 20 or fuel cell stack 12 may operate in a functional range that may be different than that indicated by the curve 160 in FIG. 2. The fuel cell system 10 may operate at higher pressures (e.g., the highest anode inlet manifold pressure (P_{AIM_HI}) 110) or at a current density 108 as low as the critical current density (i__{LO_CR}) 130. For example, the fuel cell system 10 may extend steady state operation at about 2.5 bara down to about the critical current density (i__{LO_CR}) 130. Pressure measurements in bara refer to the absolute pressure in bar.

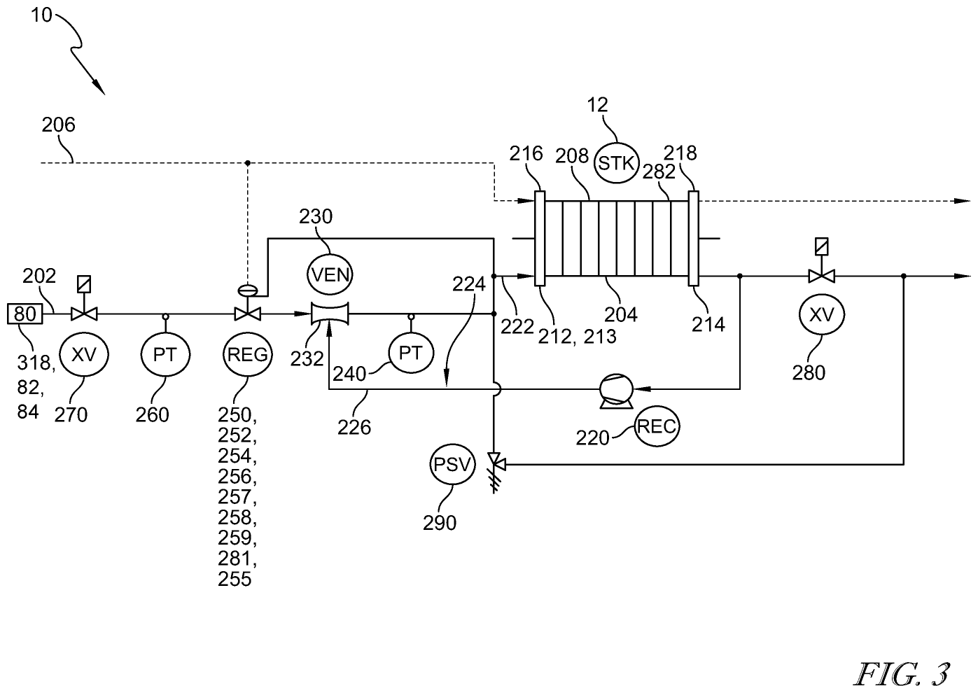

FIG. 3 illustrates one embodiment of a fuel cell system 10 comprising a fuel cell stack 12, a mechanical regulator 250, a recirculation pump or blower 220 in series or in parallel to the fuel cell stack 210, an exhaust valve 280, a shut off valve 270, a pressure transfer valve 290, one or more pressure transducers 240/260, and a venturi or ejector 230. In some embodiments, the fuel cell system 10 may comprise one or more fuel cell stacks 12 or one or more fuel cells 20. In other embodiments, there may also be one or multiple valves, sensors, compressors, regulators, blowers, injectors, ejectors, and/or other devices in series or in parallel with the fuel cell stack 12.

In one embodiment of the fuel cell system 10, an anode inlet stream 222, flows through an anode 204 end of the fuel cell stack 12. Typically, the anode inlet stream 222 may be a mixture of fresh fuel (e.g., H₂) and anode exhaust (e.g., H₂ fuel and/or water). Conversely, oxidant 206 (e.g., air, oxygen, or humidified air) may flow through the cathode 208 end of the fuel cell stack 12.

Excess fuel may be provided at the anode inlet 212 to avoid fuel starvation towards the anode outlet 214. Water content of the anode inlet stream 222 or the relative humidity of the anode inlet stream 222 may impact the performance and health of the fuel cell stack 12. For example, low inlet humidity may lead to a drier membrane electrode assembly (MEA) 22, resulting in reduced performance. Low inlet humidity may also induce stresses that can lead to permanent damage to the membrane electrode assembly (MEA) 22. High humidity levels may lead to flooding within the fuel cell 20 or fuel cell stack 12, which can induce local starvation and/or other effects that may reduce fuel cell performance and/or damage the membrane electrode assembly (MEA) 22. In some embodiments, there may be an optimal inlet relative humidity range in which fuel cell performance is improved and membrane electrode assembly (MEA) 22 degradation rate is minimized. For example, the fuel cell 20 or fuel cell stack 12 may achieve optimal performance when the relative humidity level of the anode inlet stream 222 is in the range of about 30% to about 35%, including any percentage or range comprised therein.

The source of the excess fuel and water content in a fuel cell 20 may be from a secondary or recirculated flow 226. Composition of the secondary flow 226 in the fuel cell system 10 is dependent on its composition of anode outlet stream 225. In some embodiments, the anode outlet stream 225 may be saturated with water at a given anode gas outlet temperature and pressure. Thus, the variation in the composition of the secondary flow 226 may be taken into account when determining a required secondary flow 226 to meet the excess fuel or relative humidity targets of the anode inlet stream 222.

The required flow rate of the secondary flow 226 can be determined by either the need for excess fuel, or by the need for increased water content, whichever calls for a higher flow of the secondary flow 226. The required flow of the secondary flow 226 can be expressed as the target entrainment ratio (ER). Alternatively, a target effective excess fuel ratio or a minimum required fuel ratio may account for either the need for excess fuel, or for the increased water content of the anode inlet stream 222.

Excess fuel ratio (λ) or the anode stoichiometry ratio is defined as the ratio of anode inlet fuel flow rate to the fuel consumed in the fuel cell 20 or fuel cell stack 12. Excess fuel ratio (λ) may be used to represent the required composition of the secondary flow 226 to meet the required anode inlet stream 222 characteristics. The required anode inlet stream 222 characteristics may be the more stringent of excess fuel ratio or relative humidity requirements of the fuel cell system 10.

Excess fuel ratio (λ) or the anode stoichiometry ratio is defined as the ratio of anode inlet stream 222 flow rate to the fuel consumed in the fuel cell 20 or fuel cell stack 12. Minimum required excess fuel ratio 140 as a function of current density 108 is shown in FIG. 2. In some embodiments, the fuel cell system 10 requires a fuel amount at or above the minimum required excess fuel ratio 140. In other embodiments, the fuel cell system 10 may requier a target water or humidity level, which may affect the excess fuel ratio (λ) 140. The excess fuel ratio (λ) 140 may be flat across the fuel cell system 10 operating range except at low current densities 108, such as at a current density 108 at or below an excess fuel ratio current density threshold (i__{λ_THV}) 150. Alternatively, or additionally, the excess fuel ratio (λ) 140 may change with a change in current density 108. In some embodiments, the excess fuel ratio (λ) 140 above the excess fuel ratio current density threshold (i__{λ_THV}) 150 may be in the range from about 1.3 to about 1.9, including any ratio comprised therein. In one preferable embodiment, the excess fuel ratio (λ) 140 above the excess fuel ratio current density threshold (i__{λ_THV}) 150 may be in the range of about 1.4 to about 1.6, including any ratio or range of ratio comprised therein.

In some embodiments, the excess fuel ratio current density threshold (i__{λ_THV}) 150 of the fuel cell system 10 may be at or about 0.2 A/cm². In other embodiments, the excess fuel ratio current density threshold (i__{λ_THV}) 150 may be at a different current density 108. For example, the excess fuel ratio current density threshold (i__{λ_THV}) 150 may be at a current density 108 in the range of about 0.05 A/cm² to about 0.4 A/cm², including any current density 108 or range of current density 108 comprised therein. In one preferable embodiment, the excess fuel ratio current density threshold (i__{λ_THV}) 150 may be about 0.1 A/cm² or about 0.2 A/cm². The excess fuel ratio current density threshold (i__{λ_THV}) 150 may depend on the operating conditions of the fuel cell 20 or fuel cell stack 12.

In one embodiment, if the fuel cell 20 or fuel cell stack 12 is operating below the excess fuel ratio current density threshold (i__{λ_THV}) 150, a minimum volumetric flow rate may be maintained through the anode 204 to flush out any liquid water that might form in the fuel cell 20 or fuel cell stack 12. At low flow rates (e.g., below about 0.2 A/cm² or below about 0.1 A/cm²), there may be flooding in the fuel cell 20 or fuel cell stack 12. If the minimum volumetric flow rate is below the excess fuel ratio current density threshold (i__{λ_THV}) 150, the rate of fuel cell 20 or fuel cell stack 12 degradation may increase.

A venturi or ejector 230 may be used in the fuel cell system 10. The venturi or ejector 230 may be sized, such that the fuel cell system 10 may not require the assistance of a recirculation pump 220, such as a blower, at certain current densities 108. Absence of usage of the recirculation pump or blower 220 may result in a decrease in parasitic load, as shown by the curves 170 and 180 of FIG. 2. The curve 170 shows a fraction of flow that is delivered by the recirculation pump or blower 220 in the absence of a venturi or ejector 230. The curve 180 shows the corresponding parasitic load. The parasitic load may increase with an increase in current density, as shown by the curve 180, because recirculation pump or blower 220 may function at a capacity proportional to pressure loss in the fuel cell 20 or fuel cell stack 12 and/or proportional to the required flow rate of the secondary flow 226 in the fuel cell 20 or fuel cell stack 12.

The fuel cell 20 or fuel cell stack 12 may be initially operating at high current density 138, at high operating temperatures and pressures such that the fuel cell load under this initial operating condition is high. The fuel cell load is defined as:

Load=stack power=current×fuel cell or fuel cell stack voltage=current density×fuel cell area×fuel cell or fuel cell stack voltage

The fuel cell 20 or fuel cell stack 12 may be in a load shedding state when the load demand for power is rapidly reduced or shed requiring the fuel cell 20 or fuel cell stack 12 to reduce the current delivered.

During transient operations in the fuel cell 20 or fuel cell stack 12, the operating pressure in the fuel cell 20 or fuel cell stack 12 may change based on the changes in the fuel cell 20 or fuel cell stack 12 operating temperature. For example, during load shedding, the fuel cell system 10 may have an operating pressure that corresponds to a transient operating pressure (P__{AIM_TRS}) that may be greater than its steady state operating pressure (P__{AIM_SS}). In some embodiments, the transient operating pressure (P__{AIM_TRS}) may equal the highest anode inlet manifold pressure (P_{AIM_HI}) 110 even at low current densities 108. During load acceptance, the rate of increase in current density 108 is limited, and the steady state operating pressure (P__{AIM_SS}) may equal the anode inlet manifold pressure (P_{AIM}).

In one embodiment, the operating pressure of the fuel cell 20 or fuel cell stack 12 may optimize the balance between enabling efficient fuel cell 20 or fuel cell stack 12 operation and the parasitic load required to operate at the chosen operating pressure (e.g., the parasitic load of an air compressor, a blower, and/or a pump). In some embodiments, the operating temperature, operating pressure, and/or excess air ratio 140 may maintain a target relative humidity (RH) for the fuel cell 20 or fuel cell stack 12 operation. The operating temperature, operating pressure, and/or excess air ratio 140 may be determined by targeting a specific value for the relative humidity (RH) at the cathode 208.

The excess air ratio is defined similarly to excess fuel ratio 140, but refers to the cathode 208 side flow (i.e., excess O₂ in the air). The combination of excess air ratio, pressure and temperature are used together to control humidity on the cathode 208 side, which in turn impacts water content on the anode 204 (H₂) side. In one embodiment, temperature, pressure, and excess air ratio that vary with current density may be used to control humidity on the cathode 208 side. In some embodiments, excess air ratio may be about 2.0. In other embodiments, excess air ratio may be in the range of about 1.7 to about 2.1, including any ratio or range of ratio comprised therein. In some other embodiments, excess air ratio may be in the range of about 1.8 to about 1.9, including any ratio or range of ratio comprised therein, under pressurized operation. Excess air ratio may increase to below an air threshold current to keep volumetric flow rate high enough to prevent flooding in the fuel cell 20 or fuel cell stack 12 on the cathode 208 side.

The target relative humidity (RH) may be maintained by using a humidification device in combination with the operating pressure and operating temperature. For example, a humidification device may be used on the cathode 208 side of the fuel cell 20 or fuel cell stack 12. If the target relative humidity (RH) and the target operating pressure of the fuel cell 20 or fuel cell stack 12 are specified, the target temperature for the fuel cell 20 or fuel cell stack 12 operation may be determined.

The mechanical regulator 250 is a control valve 254 that may be used to control the flow of fresh fuel 202 also referred to as primary flow, primary mass flow, primary fuel, or motive flow to the anode 204. Pressure differential between the gas streams (e.g. anode inlet stream 222 and air 206) at the anode 204 and the cathode 208 may provide an input signal 256 to a controller 252 in the mechanical regulator 250.

The controller 252 of the mechanical regulator 250 may determine the flow of the anode inlet stream 222 through an anode inlet 212 at the anode 204. The control valve 254 may be a proportional control valve, or an injector. In other embodiments, the control valve 256 may comprise an inner valve 258, coil 255, or solenoid 257 that controls the opening or closing of the control valve 254. The input signal 256 from the anode 204 and/or cathode 208 of the fuel cell 20 or fuel cell stack 12 may be a physical signal 256 or a virtual (e.g., an electronic) signal 256. The signal may be any type of communicative or computer signal 256 known in the art.

Flow rate of the primary fuel 202 or primary flow rate may be controlled to match the fuel consumption in the fuel cell stack 12 based on the operating pressure (e.g., anode pressure). In some embodiments, the pressure in the anode 204 may stabilize when fuel consumption matches the fresh fuel feed at the anode 204 assuming that all other parameters are equal. Since the functioning of the mechanical regulator 250 is based on the pressure differential between the anode 204 and cathode 208, a target pressure differential needs to be maintained when using the mechanical regulator 250. In some embodiments, pressure at the cathode 208 is controlled and/or maintained at a target level via cathode side controls 282.

A mechanically regulated approach, such as by employing actuators 282, may use pressure signals 281 from cathode/air inlet 216 to control mass flow and maintain an appropriate pressure on the cathode 208 side of the fuel cell stack 12. In some embodiments, pressure signals 218 from cathode 208 side are inputs to the mechanical regulator 250. In some embodiments, the anode 204 side mass flow and anode 204 side pressure may be controlled by using the pressure signals 281 from cathode 208 side and measuring one or more anode 204 side conditions.

The pressure signals 281 from cathode 208 side may change the position of an inner valve 258 in the mechanical regulator 250 to control mass flow through the mechanical regulator 250 and maintain the target pressure differential between the anode 204 and the cathode 208. The input signal 256 that acts on the mechanical regulator 250 is effectively a pressure differential that acts on a diaphragm 257 or other parts of the mechanical regulator 250. No other direct measurement of the pressure differential may be undertaken. A single point pressure at the anode 204 may be calculated to be the cathode 208 side pressure plus the pressure differential between the gas streams (e.g., 222) at the anode 204 and the gas streams (e.g., 206) at the cathode 208.

The venturi or ejector 230 may draw the secondary flow 226 also referred to as secondary mass flow, entrainment flow, or recirculation flow, using a flow pressure across an anode gas recirculation (AGR) loop 224. In some embodiments, the anode gas recirculation loop 224 may include the venturi or ejector 230, the fuel cell stack 12, and a secondary inlet 232, such as one comprised in a suction chamber 234 in the venturi or ejector 230, and/or other piping, valves, channels, manifolds associated with the venturi or ejector 230 and/or fuel cell stack 12. The recirculation pump or blower 220 may increase or decrease the differential pressure across the AGR loop 224.

The fuel cell system 10 may require a target water or humidity level, which may drive the flow of saturated secondary flow 226. The saturated secondary flow 226 may then drive the primary flow 202, such that the target excess fuel ratio (λ) 140 may be dependant on the target water or humidity level.

The venturi or ejector 230 may be required to operate and/or perform robustly to deliver the required primary flow 202 at the required excess fuel ratio (λ) 140. Operating characteristics of the recirculation pump or blower 220 may be distinct from a venturi or ejector 230. The secondary flow may enter the venturi or ejector 230 through a secondary inlet 232 in a suction chamber 234 at a secondary inlet pressure (P_{S}) and a secondary inlet temperature (T_{S}).

The turn down ratio of the fuel cell system 10 is defined as the ratio of the maximum capacity of the venturi or ejector 230 to the minimum capacity of the venturi or ejector 230. The fuel cell system 10 may be designed to maximize the venturi or ejector 230 turn down ratio. Consequently, maximizing the turn down ratio of the venturi or ejector 230 also works to minimize the size and parasitic load associated with the recirculation pump (blower) 220.

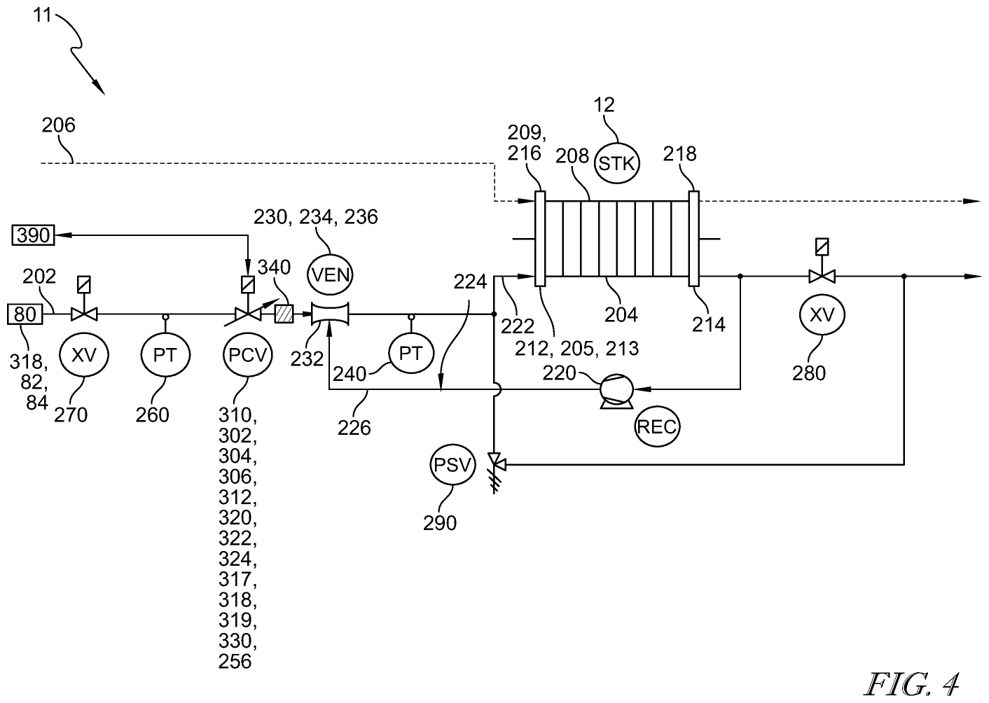

In one embodiment, as illustrated in a fuel cell system 11 shown in FIG. 4, a proportional control valve 310 may be used instead of the mechanical regulator 250. The proportional control valve 310 is electronically controlled and may provide more flexibility in controlling the single point pressure at the anode 204 than a mechanical regulator 250. The proportional control valve 310 may be used to control the primary flow 202 in the fuel cell system 11. The flexibility provided by the proportional control valve 310 may be advantageous when there is a change in pressure differential due to change in the operating current density 160 or when the fuel cell system 10/11 is under transient conditions

For example, the proportional control valve 310 may beneficially allow for active management of the differential pressure, may avoid droop issues, and/or provide flexibility in operating the fuel cell stack 12 under different operating conditions. Illustrative operating conditions may include, but are not limited to operating current density, operating pressure, operating temperature, operating relative humidity, fuel supply pressure, fuel supply temperature, required secondary flow, entrainment ratio, parasitic load limitations, power needs, pressure loses in the anode gas recirculation loop 224, venturi or ejector 230 performance and/or efficiency, recirculation pump or blower 220 performance and/or efficiency, fuel density, purge flow, and choked or unchoked (e.g., not choked) flow conditions.

The control valve 254, such as the mechanical regulator 250, the proportional control valve 310, or an injector (not shown), may be sized to allow a maximum fuel flow rate that may be required. In some embodiments, the maximum fuel flow rate required may include the fuel consumed within the fuel cell stack 12, plus any fuel lost from the fuel cell system 10/11 due to purge flow. The fuel cell system 10/11 may purge a small amount of fuel (e.g., about 10%). In other embodiments, the system may purge more or less than about 10% of the fuel flowing through the fuel cell stack 12. The purge flow of fuel may be instantaneous or may occur at fixed or changing time intervals. Thus, the required mass flow rate of fuel may be about 10% higher than the mass flow rate when the system 10/11 is not purging any fuel.

In one embodiment, the control valve 254 of the system 10/11 may accurately control the fresh fuel flow 202 and maintain the pressure differential between the anode 204 and the cathode 208 of the fuel cell stack 12. Target pressure at the anode 204 side (P_{ANODE}) may depend on pressure at the cathode 208 side (P_{CATHODE}) and a bias pressure (ΔP_{BIAS}).

P_{ANODE}=P_{CATHODE}+ΔP_{BIAS} (1)

In one embodiment, the pressure measured at the anode 204 side (P_{AN_MEASURED}) may be different than the target anode pressure (P_{ANODE}). The differential pressure (AP) between the anode 204 and the cathode 208 is determined as follows.

ΔP=P_{AN_MEASURED}−P_{CATHODE}=P_{AN_MEASURED}−P_{ANODE}+ΔP_{BIAS} (2)

In one embodiment, fuel (e.g., H₂) is supplied to the fuel cell system 10/11 by a fuel supply system 80, such as H₂ storage tanks 82 with flow regulators 84. A fuel supply pressure (P_{CV}) may be controlled upstream of a control valve 256 (e.g., a mechanical regulator 250, a proportional control valve 310, or an injector). The fuel supply pressure (P_{CV}) is kept at a constant value ranging from about 7 bara to about 20 bara, including any pressure or range of pressure comprised therein. In an illustrative embodiment, the fuel supply pressure (P_{CV}) is kept at a constant value of about 12 bara. There may be some variability in the fuel flow rate from the fuel supply system 80, such that there may be droop in the system 10/11.

A fuel supply temperature (T_{CV}) upstream of a control valve 256 may vary depending on ambient conditions such as temperature, pressure, and/or relative humidity. The fuel supply temperature (T_{CV}) may vary from about −20° C. to about 100° C., including any temperature or range of temperature comprised therein. The fuel cell system 10/11 may need to be protected from variations in the fuel supply temperature (T_{CV}) due to variation in ambient conditions.

The control valve 256 may be sized based on a certain fuel sizing pressure (P__{CV_MN}) and a certain fuel sizing temperature (T__{CV_SZ}). In some embodiments, the position of the inner valve 258 inside the control valve 256 (e.g., the mechanical regulator 250) during operation may decrease the control valve 256 opening if the fuel supply pressure (P_{CV}) is higher than the fuel sizing pressure (P__{CV_MIN}). This may also occur if the fuel supply temperature (T_{CV}) is lower than the fuel sizing temperature (T__{CV_SZ}).

The fuel supply pressure (P_{CV}) may stay absolutely or approximately constant. The anode inlet manifold pressure (P_{AIM}) may decrease with the fuel flow rate. In other embodiments, the difference between the fuel supply pressure (P_{CV}) and the anode inlet manifold pressure (P_{AIM}), as determined by P_{CV}-P_{AIM}, may increase with the flow rate of the primary flow 202. In some embodiments, the inner valve 258 opening of the control valve 256 downstream of the fuel supply system 80 may be sized such that the inner valve 258 opening of the control valve 256 may operate under choked flow conditions at the inner valve 258 orifice. Thus, the flow rate of the primary flow 202 may be controlled directly based on the control valve 256 position and the flow rate may not be sensitive to any downstream pressure.

A pressure recovery factor (PRF) may be important under high primary flow conditions, such as when the operating current density 160 is close to the highest current density 138, such as at about 1.6 Amps/cm² as demonstrated in FIG. 2. The pressure recovery factor (PRF) is determined as follows.

PRF=√[(P₁−P₂)/(P₁−P_{VC})] (3)

P₁ is an upstream pressure measured upstream of the control valve 256, such as the fuel supply pressure (P_{CV}). P₂ is a downstream pressure measured downstream of the control valve 256. P₂ is the anode inlet manifold pressure (P_{AIM}) if the fuel cell system 10/11 does not have a venturi or ejector 230 or is a primary nozzle inlet pressure (P_{O}) if the system 10/11 has a venturi or ejector 230. The primary nozzle inlet pressure (P_{O}) is the pressure at the primary nozzle 236 of the venturi or ejector 230. P_{VC} is the pressure at the vena contract 259 of the control valve 256 such as the mechanical regulator 250.

If the pressure recovery factor (PRF) is equal to 1, then downstream pressure (P₂) is equal to the upstream pressure (P₁) divided by 1.9. In some embodiments, if the operating system 10/11 does not have a venturi or ejector 230, the anode inlet manifold pressure (P_{AIM}) of the system 10/11 is equal to the upstream pressure (P₁) divided by 1.9. In other embodiments, if the fuel cell system 10/11 has a venturi or ejector 230, the primary nozzle inlet pressure (P_{O}) of the fuel cell system 10/11 is equal to the upstream pressure (P₁) divided by 1.9. In some embodiments, the primary nozzle inlet pressure (P_{O}) of the fuel cell system 10/11 may influence the sizing of a primary nozzle (“nozzle”) 236 of the venturi or ejector 230.

The pressure recovery factor (PRF) at the highest primary fuel flow of the fuel cell system 10/11 may be used to determine either: (a) the fuel sizing pressure (P__{CV_MIN}) which may be the minimum fuel supply pressure required for a given maximum primary nozzle inlet pressure (P_{O_MAX}) and/or (b) the maximum primary nozzle inlet pressure (P_{O_MAX}) at the given the fuel sizing pressure (P__{CV_MIN}) which may be the minimum fuel supply pressure. The primary nozzle 236 of the venturi or ejector 230 may be sized to deliver required fuel flow, including purge flow, at empty pressure conditions (P_{EMPTY}).

Empty pressure conditions (P_{EMPTY}) comprise conditions when the primary nozzle inlet pressure (P_{O}) is or is about equal to the maximum primary nozzle inlet pressure (P_{O_MAX}). The maximum primary nozzle inlet pressure (P_{O_MAX}) depends on the pressure recovery factor (PRF) and the fuel sizing pressure (P__{CV_MIN}). In some embodiments, the empty pressure (P_{EMPTY}) may be greater than or less than about 12 bara. In other embodiments, the empty pressure (P_{EMPTY}) may be at or about 12 bara.

The inverse sympathetic ratio (ISR) of the control valve 256 (e.g., mechanical regulator 250, proportional control valve 310, or injector) may also be important for measuring and/or determining the pressure differential conditions. The inverse sympathetic ratio (ISR) characterizes the sensitivity of force balance on the control valve 256 to downstream pressure (P₂). If the fuel cell system 10/11 does not have a venturi or ejector 230, the downstream pressure (P₂) is the anode inlet manifold pressure (P_{AIM}). If the fuel cell system 10/11 has a venturi or ejector 230, the downstream pressure (P₂) is the primary nozzle inlet pressure (P_{O}).

The inverse sympathetic ratio (ISR) may have a measureable and/or noticeable effect on the fuel cell system 10/11. The inverse sympathetic ratio (ISR) may help to reduce leakage in the control valve when under high pressure differential conditions, such as at or about 20 bara. If the control valve 256 comprises a dome regulated mechanical valve 250, the inverse sympathetic ratio (ISR) may introduce a non-linearity in the flow through the control valve 256 as it relates to the dome load pressure differential.

For example, at high current density 138 (e.g., about 1.6 Amps/cm²), the downstream pressure (P₂, such as P_{AIM}) may be higher than the downstream pressure (P₂) at low current density 139 which is less than or about the critical current density (i__{LO_CR}) 130 of the fuel cell system 10/11 based on the operating conditions. A high downstream pressure (P₂), such as at or about 2.5 bara, may increase the inner valve 258 opening in the mechanical regulator 250 even if the bias pressure (ΔP_{BIAS}) remains the same. Thus, mass flow through the mechanical valve 250 may be higher. A higher bias pressure (ΔP_{BIAS}) may result under high current density 138 conditions (e.g., about 1.6 Amps/cm²).

Under transient conditions, when the downstream pressure (P₂, such as P_{AIM}) stays at or about 2.5 bara, at low current densities 139 (e.g., less than critical current density (i__{LO_CR}) 130) based on the operating conditions, the mass flow rate in the fuel cell system 10/11 may be higher than when the fuel cell system 10/11 is operating at the steady state due to the ISR effect. The selection and/or sizing of the mechanical valve 250 may account for, compensate for, or operate based on the non-linearity introduced due to the inverse sympathetic ratio (ISR) to ensure the target bias pressure (P_{BIAS}) is maintained across the entire operating range of the fuel cell system 10/11.

Inaccurate measurements of pressure can cause gas diffusion resulting in a high concentration of contaminant gases on at the anode 204 side, reduced fuel cell stack 12 efficiency, and/or higher purge rates in the fuel cell stack 12. If higher pressure differentials are allowed because of inaccurate pressure measurements at the anode 204 or at the cathode 208, there may be mechanical damage to the fuel cell stack 12 (e.g., MEA 22 fatigue and/or failure). This is especially important when using the proportional control valve 310 because when the mechanical regulator 250 is used, the effective pressure differential between the anode 204 and the cathode 208 is measures instead of the single point pressure at anode 204 and the single point pressure at cathode 208 is measured. The spring strength of the mechanical regulator 250 can be chosen to ensure that the mechanical regulator 250 is able to measure the pressure differential.

Similarly, if the fuel cell system 10/11 comprises a proportional control valve 310, an actuator 304 may be signaled by the one or more controllers 302 of the proportional control valve 310 to keep the inner valve 306 of the proportional control valve 310 in a particular position. The particular position may be determined by the controller 302. The proportional control valve 310 may be used in combination with a venturi or ejector 230. The one or more controllers 302 of the proportional control valve 310 may measure, account for, or correct for the non-linear dynamics when the primary nozzle 236 of the ejector 230 is not choked. The one or more controllers 302 of the proportional control valve 310 may measure, account for, or correct for the non-linear dynamics when the primary nozzle 236 of the ejector 230 is choked. The signal 312 sent to the actuator 304 may be influenced by the inverse sympathetic ratio (ISR).

In one embodiment, the one or more controllers 302 of the proportional control valve 310 may proactively account for sensitivity of the proportional control valve 310 position to downstream pressure (P₂). The one or more controllers 302 may proactively account for the situation where the primary nozzle 236 is no longer choked under low current conditions 139. The one or more controllers 302 of the proportional control valve 310 may proactively determine an actuator 304 command or signal 312 to move the inner valve 306 opening of the proportional control valve 310 into a position that will deliver the desired mass flow rate based on the operating conditions of the fuel cell system 10/11. The one or more controllers 302 of the proportional control valve 310 may transition to linear dynamics when the venturi or ejector 230 is operating with the primary nozzle 236 choked.

An important consideration when using a proportional control valve 310 as a control valve 256 of the fuel cell system 10/11 is ensuring accurate measurement of the single point pressure at the anode 204 and at a single point pressure at the cathode 208. If the single point pressure at the anode 204 and at the single point pressure at the cathode 208 is not measured accurately, the pressure at the anode 204 and at the cathode 208 cannot be accurately controlled by one or more controllers 302 of the proportional control valve 310. The single point pressures at anode 204 and cathode 208 may be absolute pressure or gauge pressure.

The downstream pressure (P₂), such as the primary nozzle inlet pressure (P_{O}), may be predicted based on compressible gas equations and/or configuration of the venturi or ejector 230. The downstream pressure (P₂) may be predicted for choked nozzle conditions. In other embodiments, the downstream pressure (P₂) may be predicted for unchoked nozzle conditions.

The proportional control valve 310 may comprise a dual control loop 320. The proportional control valve 310 may comprise an inner control loop 322 and an outer control loop 324. The inner control loop 322 may use the pressure around the proportional control valve 310 to determine one or more signals 312 sent to the actuator 304 associated with proportional control valve 310. In some embodiments, the inner control loop 322 may be an open loop method based on downstream pressure (P₂) estimated using a target fuel (e.g., H₂) flow rate. The inner control loop 322 may use a force balance and/or ISR compensation based on virtual estimates to generate the signal 312 that is sent to the actuator 304 associated with proportional control valve 310.

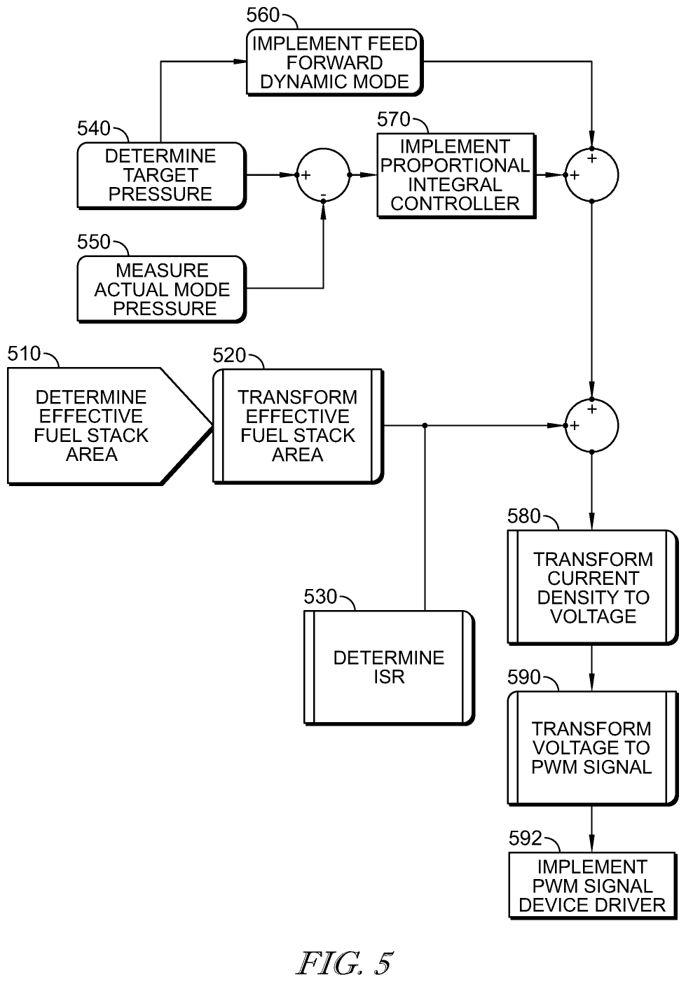

In one illustrative embodiment of the present operating method, as shown in FIG. 5, steps 540, 550, 560, and 570 may comprise the outer control loop 324. The target anode pressure (P) may be determined in step 540. The actual anode pressure (P_{AN_MEASURED}) may be measured in step 550.

A feedforward dynamics model may be implemented in step 560. The feedforward dynamics model may be in the form of a transfer function. The transfer function may be determined by utilizing classical system identification techniques. A proportional-integral controller 572 may be implemented in step 570. The objective of this step is to correct for modeling any errors in the fuel cell system 10/11.

In one illustrative embodiment, as shown in FIG. 5, steps 510, 520, 530, 580, 590, and 592 may comprise the inner control loop 322. Stack operating conditions, such as stack current, fuel supply pressure (P_{CV}), and/or fuel supply temperature (T_{CV}), may be used to determine an effective fuel cell stack area (Ac) in step 510. In step 520, a map is used to transform the effective stack area (Ac) to current density.

In some embodiments, the map is based on the data collected on an actual proportional control valve 310. In other embodiments, the map could be in the form of a table with effective stack area (Ac) as an input, and the measured current density at a solenoid 317 of the proportional control valve 310 as the output. In some other embodiments, the map could be based on one or more regression equations. In one embodiment, the inverse sympathetic ratio (ISR) of the proportional control valve 310 may be determined in step 530.

In one embodiment, current density to voltage transformation occurs in step 580. The voltage needed to drive the required current density through the solenoid 317 of the proportional control valve 310 may be determined. In some embodiments, voltage is determined by utilizing electrical parameters of the solenoid 317, such as solenoid resistance, leakage resistance, magnetizing inductance, solenoid current command, time derivative of valve displacement and/or time derivative of solenoid current. In other embodiments, the voltage needed to drive the required current density through a different mechanical component of the proportional control valve 310 (e.g., valve, coil etc.) and the electrical parameters of that mechanical component may be determined.

The voltage may be transformed to an electrical signal 312 that can be input to the proportional control valve 310. In one illustrative embodiment, the voltage may be transformed to a pulse width modulated (PWM) signal 591 in step 590. In some embodiments, the voltage to the pulse width modulated (PWM) signal 591 may be done by a scaling equation. In other embodiments, the voltage to a pulse width modulated (PWM) signal 591 may be calculated as follows.

PWM Duty Cycle=100*(Voltage/Max Supply Voltage) (percent) (4)

A pulse width modulated (PWM) signal device driver 592 is implemented in step 594. In some embodiments, the pulse width modulated (PWM) signal device driver 592 may be in the form of an electronic device. The pulse width modulated (PWM) signal device driver 592 may be a metal oxide semiconductor field effect transistor (MOSFET). The duty cycle of the pulse width modulated (PWM) signal device driver 592 may be adjusted to meet the percent pulse width modulated (PWM) signal duty cycle.

The proportional control valve 310 may compensate for the fuel supply temperature (T_{CV}). In some embodiments, the fuel supply temperature (T_{CV}) may be determined by a physical and/or virtual sensor 318 and may be based on information from the fuel supply system 80 (e.g., ambient conditions, etc.). In other embodiments, the fuel supply temperature (T_{CV}) may be determined from a fuel management system 210 in the fuel cell system 10/11.

Temperature within the fuel cell system 10/11 comprising the fuel management system 210 may be representative of the fuel supply temperature (T_{CV}). The fuel supply temperature (T_{CV}) may be estimated from the temperature within the fuel cell system 10/11 comprising fuel management system 210. The outer control loop 324 may apply correction using measured pressure via a pressure transmitter 319 that measures the anode inlet manifold pressure (P_{AIM}) (e.g., PT-1006). The pressure transmitter 319 may send one or more signals 312 to the one or more controller 302 associated with proportional control valve 310.

The proportional control valve 310 may be designed to achieve substantial pressure recovery at the maximum primary flow rate of fuel (e.g., H₂) through the proportional control valve 310 (e.g., under choked conditions). The proportional control valve 310 may be designed to provide the maximum primary nozzle inlet pressure (P_{O_MAX}) at a given usable H₂ storage tanks 82 (e.g., fuel tank) fraction. The proportional control valve 310 may be designed to provide the maximum usable H₂ storage tanks 82 (e.g., fuel tank) fraction at a given maximum primary nozzle inlet pressure (P_{O_MAX}).

The flow rate through the proportional control valve 310 may decrease below the maximum primary flow rate, and substantial pressure recovery may not occur in the fuel cell system 10/11. Lack of pressure recovery may impact the force balance on the proportional control valve 310. The actuator 304 in the proportional control valve 310 may be configured to respond to any change in the force balance on the proportional control valve 310.

Inaccurate pressure measurements at the anode 204 and the cathode 208 may result in error propagation. In one embodiment, the single point pressure sensors 205, 209 may be used at the anode inlet 212 and/or the cathode inlet 216 respectively. For example, if single point pressure sensors, such as the anode side pressure sensor 205 and the cathode side pressure sensor 209, are used to measure the pressure at the anode inlet 212 (P1) and cathode inlet 216 (P2), the pressure differential (ΔP) is determined as follows and further described in Table 1.

ΔP=P1−P2 (5)

TABLE 1

| | | | | one | | standard error | |
|---|---|---|---|---|---|---|---|
| | | | | sigma | | (one sigma) | |
| P1= | 2.50 | [bara] | xₚ₁= | 1.0% | | 0.025 | [bara] |
| P2= | 2.25 | [bara] | xₚ₂= | 1.0% | | 0.023 | [bara] |
| ΔP= | 0.10 | [bara] | x_{Δp}= | 0.034 | [bara] | | |

As shown in Table 1, even if the single point pressure sensors 205, 209 are accurate, the standard error in each measurement may be +/−0.1 bara. Furthermore, error propagation impacts the accurate measurement of ΔP. The single point standard error is 0.034 bara. The uncertainty in ΔP at 95% confidence is determined a follows.

ΔP=0.1+/−1 0.067 bar (6)

In one embodiment, such error in measuring the single point pressures at the anode 204 (e.g., at the anode inlet 212) and the cathode 208 (e.g., at the anode inlet 216), and hence the error in accurately determining the pressure differential (ΔP) between the anode 204 side and the cathode 208 side, could exist from the beginning of use of the fuel cell stack 12 comprising the anode 204 and the cathode 208. In other embodiments, the error in measuring the single point pressures at the anode 204 (e.g., at the anode inlet 212) and the cathode 208 (e.g., at the anode inlet 216) may occur with sensor 205, 209 aging and/or drift over time.

A pressure differential sensor 211 that measures the pressure difference between the anode 204 and the cathode 208 may be used in addition to or instead of the single point pressure sensors at the anode 204 and the cathode 208. The pressure differential sensor 211 may be designed to ensure that there is no crossover between the air 206 on the cathode 208 side and the anode inlet stream 222 (e.g., fuel, hydrogen) on the anode 204 side.

The design requirements of the single point pressure sensors 205, 209 at the anode 204 side and the cathode 208 side may allow for minimal standard error during each measurement of single point pressure. This may minimize error propagation when calculating the differential pressure (ΔP). In some embodiments, the standard error may be required to be below a threshold, such as within about 0.5% to about 1% of the full scale, such that the error is reduced to below about 1.0 kPa to about 5 kPa. In other embodiments, the standard error may be less than about 25% of the target bias pressure (P_{BIAS}).

In one embodiment, the target differential pressure (ΔP) may be changed to account for any error propagation. Altering the target pressure differential (ΔP) may reduce the effect of any error in single point pressure measurements. However, altering the target pressure differential (ΔP) may increase the stress on the fuel cell stack 12.

In one embodiment, the minimum target bias pressure (P_{BIAS_MIN}) required to minimize cross-over between the anode 204 and the cathode 208 may be determined after accounting for any uncertainty in sensing pressure and any uncertainty in a control system 330 comprising the one or more controllers 302 of the proportional control valve 310. In some embodiments, the target bias pressure (P_{BIAS}) and/or thresholds associated with standard errors may vary with operating condition. In some embodiments, the target bias pressure (P_{BIAS}) and/or thresholds associated with standard errors may be a function of gross current and/or current density 108 of the fuel cell system 10/11.

For example, if the minimum target bias pressure (P_{BIAS_MIN}) is about 10 kPa, the one or more controllers 302 of the proportional control valve 310 may target a bias pressure (P_{BIAS}) with a certain offset. In some embodiments, the offset may be calibrated based on a known uncertainty in the single point pressure sensors 205, 209 as follows.

P_{BIAS}=P_{BIAS_MIN}+P_{OFFSET} (7)

In one embodiment, if the minimum acceptable bias pressure is P_{BIAS_MIN}, to account for the uncertainty, a nominal bias pressure may be defined as follows.

P_{BIAS_NOM}=P_{BIAS_MIN}+P_{OFFSET} (8)

P_{BIAS_SIGMA}=Z×σ__{dP_ERROR} (9)

For 95% confidence, Z is equal to 2 and with σ__{dP_ERROR} is equal to 3.43 kPa

P_{OFFSET}=6.8 kPa (10)

In one embodiment, the control system 330 comprising the one or more controllers 302 of the proportional control valve 310 may operate based on controls priority. There may be multiple threshold levels used to escalate controls priority from one level to the next. As the fuel cell system 10/11 gets closer to a certain predetermined threshold limit, the one or more controllers 302 of the proportional control valve 310 may escalate the response of the proportional control valve 310 or may change demand of the proportional control valve 310. The minimum acceptable bias pressure (P_{BIAS_MIN}) may be about 0.1 bara. The bias pressure margin (P_{BIAS_MARGIN}) may be determined as follows.

P_{BIAS_MARGIN}=P_{BIAS_MEASURED}+P_{BIAS_MIN} (11)

If the bias pressure margin (P_{BIAS_MARGIN}) is greater than a first threshold, then the one or more controllers 302 may respond according to a normal or a priority level one response. If the bias pressure margin (P_{BIAS_MARGIN}) is greater than a second threshold, then the one or more controllers may respond according to an escalated or a priority level two response. If the bias pressure margin (P_{BIAS_MARGIN}) is lower than the second threshold, then the one or more controllers may respond according to a further escalated or a priority level three response.

The first threshold may range from about 5 kPa to about 20 kPa, including any threshold or range of threshold comprised therein. The second threshold may be about 2.5 kPa to about 10 kPa, including any threshold or range of threshold comprised therein. The first threshold may be lower than 5 kPa or higher than 20 kPa, including any threshold or range of threshold comprised therein. The second threshold may lower than 2.5 kPa or greater than 10 kPa, including any threshold or range of threshold comprised therein.

A purge valve 340 may be configured to assist depressurization in the fuel cell system 10/11 under certain conditions. The purge valve 340 may be used only when required. For example, a purge valve 340 may be used in some embodiments only when the threshold of the fuel cell system 10/11 exceeds the predetermined system threshold.

The proportional control valve 310 may allow for short duration transients outside the steady state operating range of the fuel cell system 10/11. The proportional control valve 310 may keep track of any time the fuel cell system 10/11 is not functioning in steady state. The proportional control valve 310 may limit deviation from steady state conditions. The fuel cell system 10/11 may use a virtual pressure model based on available volume, fuel consumption rate, temperature, and/or pressure when implementing the proportional control valve 310. The virtual pressure model may be a simulation, computer modeling, remote data, or may be based on the operation of a separate system.

The single point pressure sensors 205, 209 at the anode 204 side and the cathode 208 side may be checked and compared to each other during operation of the fuel cell stack 12. A correction may be introduced to the single point pressure sensor measurements if required. The correction may be determined by evaluating and/or comparing the single point pressure sensors 205, 209 relative to each other. When there is very low or minimal air 206 flow or anode inlet stream 222 flow during an idle state of the fuel cell stack 12, an offset in the single point pressure sensor measurements may be calculated.

When there is very little or no air 206 flow or anode inlet stream 222 flow during an off state of the fuel cell stack 12, an offset in the single point pressure sensor measurements may be calculated. If the calculated offset is higher than a flow threshold, a correction may be introduced to the single point pressure sensor measurements. The correction may be introduced to the proportional control valve 310. The flow threshold for introducing the correction may be set to when the offset is greater than about 1% of the measured value.

A disturbance may be introduced when using a proportional control valve 310. If anode inlet stream 222 flow is increased, the anode 204 side pressure may be increased in proportion to the increase in anode inlet stream 222 flow by calibrating the single point pressure sensor 205 on the anode 204 side. The proportional increase in the anode 204 side pressure may depend on size of anode 204 side of the fuel cell stack 12. The proportional increase in the anode 204 side pressure may be determined by calibrating the single point pressure sensor 205 at the anode 204 side to an expected response based on the operating conditions of the fuel cell stack 12. For example, the slope of the sensor response reflecting the sensor sensitivity may be updated based on the operating conditions of the fuel cell stack 12.

Initial off-line calibration of the single point pressure sensors 205, 209 on the anode 204 side and the cathode 208 side may be undertaken. The initial off-line calibration of the single point pressure sensors 205, 209 on the anode 204 side and the cathode 208 side may be barcoded into the one or more controllers 302 of the proportional control valve 310. The initial off-line calibration of the single point pressure sensors 205, 209 on the anode 204 side and the cathode 208 side may be communicated to the one or more controllers 302 of the proportional control valve 310 in other ways.

During a break-in period, service tools may collect calibration information and/or communicate the information to the one or more controller 302. The calibration information may also be retained by the one or more controller 302 as part of the calibration. Service tools may maintain service records for a fixed period of time.

If telematic communication devices 390 are available, data may be recorded and sent to a database where the data is analyzed. The analyzed date may be sent back to the one or more controllers 302 to update calibration. The calibration values may be checked and/or updated under one or more operating conditions.

The single point pressure sensor calibrations may be updated if single point pressure sensor measurements change over a period of time. Periodic updates may be conducted after a diagnostic analysis have been performed and sufficient time has been allowed to collect information. The sufficient time in between updates may be hours, days, or weeks. In other embodiments, the sufficient time to collect information may be hours, days, or weeks. In some other embodiments, a long term average may be maintained, where the information may be saved in the one or more controllers before any powering down or power outage occurs. In some embodiments, the information may be transferred to a memory location when the information is retained during the powering down.

In one embodiment, the single point pressure sensors 205, 209 may be located either at the anode inlet 212 or at the anode outlet 214. In one embodiment, the single point pressure sensors may be located either at the cathode inlet 216 or at the cathode outlet 218. In one embodiment the single point pressure sensors 205, 209 may be located at the anode inlet 212 and the cathode inlet 216. In other embodiments, the single point pressure sensors 205, 209 maybe located at the anode inlet 212 and the cathode outlet 218. In some embodiments, the single point pressure sensors 205, 209 maybe located at the anode outlet 214 and the cathode inlet 216. In some further embodiments, the single point pressure sensors 205, 209 maybe located at the anode outlet 214 and the cathode outlet 218. The various locations of the pressure sensors 205, 209 result in different advantages and disadvantages.

In one embodiment, a representative bias pressure measurement may needed. The representative bias pressure measurement may be a measurement that represents the stresses the fuel cell or fuel cell stack 12 membrane 22 will experience. It may be a gas diffusion process that is a driving force.

The selection of the locations of the pressure sensors 205, 209 may depend on the configuration of the cathode 208 and anode 204 flows. The outlet pressures of the respective streams (e.g., cathode 208 and anode 204 flows) represent the lowest pressure of either stream. In some embodiments, the cathode 208 and anode 204 flows may be in a cross flow configuration, and the pressure difference between cathode inlet 216 and anode outlet 214 pressures and anode inlet 212 and cathode outlet 218 pressures may be the maximum pressure difference.

In other embodiments, the cathode and anode flows may be in a co-current configuration. Space availability in the anode 204 and/or cathode 208 may also determine the location of the sensors. In one preferred embodiment, more than one single point pressure sensors 205, 209 at the anode 204 and/or more than one single point pressure sensor at the cathode 208 may be used.

The one or more controllers 302 of the proportional control valve 310 may be present inside or outside the proportional control valve 330. The one or more controllers 302 of the proportional control valve 310 may communicate with fuel management system 210 of the fuel cell stack 12 power module. The one or more controllers 302 may communicate with other components of the fuel cell system 10/11, including but not limited to one or more actuators 304 on the proportional control valve 310, the fuel cell stack 210, the recirculation pump 220, the exhaust valves 280 and 270, the pressure transfer valve 290, the pressure transducer 240, and the venturi or an ejector 230. The data or information obtained by the one or more controllers of the proportional control valve 310 may aid in the functioning of the proportional control valve 310. The information obtained by the one or more controllers 302 of the proportional control valve 310 may be based on the operating conditions of the fuel cell stack 12.

The one or more controllers 302 of the proportional control valve 310 in the fuel cell system 10/11 may communicate with the components of the fuel cell system 10/11 using one or more communication technologies (e.g., wired, wireless and/or power line communications) and associated protocols (e.g., Ethernet, InfiniBand®, Bluetooth®, Wi-Fi®, WiMAX, 3G, 4G LTE, 5G, etc.). The one or more controllers 302 of the proportional control valve 310 in the fuel cell system 10/11 may communicate with the components of the fuel cell system 10/11 in real time or automatically. In other embodiment, the one or more controllers 302 of the proportional control valve 310 in the fuel cell system 10/11 may communicate with the components of the fuel cell system 10/11 after manual operation by a user.

The following described aspects of the present invention are contemplated and non-limiting.

A first aspect of the present invention relates to a fuel cell stack system includes a fuel cell stack and a proportional control valve. The fuel cell stack includes an anode with an anode inlet and an anode outlet and a cathode with a cathode inlet and a cathode outlet. The proportional control valve controls the flow of a fuel into the anode based on a pressure differential measured across any two of the anode inlet, the anode outlet, the cathode inlet, and the cathode outlet.

A second aspect of the present invention relates to a method of implementing and/or controlling a proportional control valve in a fuel cell or fuel cell stack includes the steps of measuring a pressure differential across any two of an anode inlet, and anode outlet, a cathode inlet, and a cathode outlet of the fuel cell or fuel cell stack, flowing a fuel through the proportional control valve based on the pressure differential, and controlling the proportional control valve operation by one or more controllers. An anode includes the anode inlet and the anode outlet. A cathode includes the cathode inlet and the cathode outlet. The step of measuring the pressure differential includes using a first single point pressure sensor at the anode inlet or the anode outlet and a second single point pressure sensor at the cathode inlet or the cathode outlet.

In the first aspect of the present invention, the pressure differential may be measured by a first single point pressure sensor positioned at the anode inlet or the anode outlet and a second single point pressure sensor positioned at the cathode inlet or the cathode outlet.

In the first aspect of the present invention, measurements made by the first single point pressure sensor at the anode inlet or anode outlet and the second single point pressure sensor at the cathode inlet or cathode outlet may have a combined standard error of less than about 25% of a target bias pressure. The target bias pressure may be based on operating conditions of the fuel cell stack.

In the first aspect of the present invention, the first single point pressure sensor at the anode inlet or anode outlet and the second single point pressure sensor at the cathode inlet or cathode outlet may be subject to a calibration. The calibration may be communicated to a controller of the proportional control valve.

In the first aspect of the present invention, a controller of the proportional control valve may target a bias pressure with an offset. The offset may be calibrated based on a known uncertainty in measurements made by the first and second single point pressure sensors, and on a minimum target bias pressure. The controller of the proportional control valve may include an inner control loop and an outer control loop. The inner control loop may use a force balance or inverse sympathetic ratio (ISR) compensation method. The inner control loop may be an open loop based on pressure downstream of the proportional control valve and may be estimated using a target flow rate. The inner control loop may compensate for a fuel supply temperature measurement by using a physical or virtual sensor.

In the first aspect of the present invention, the first pressure differential may be measured by a pressure differential sensor across the anode and the cathode.

In the first aspect of the present invention, the proportional control valve may be configured to operate in combination with an ejector. The proportional control valve may include at least one controller that corrects for non-linear dynamics when a primary nozzle of the ejector is choked or not choked.

In the second aspect of the present invention, the method may further include calibrating offline the first single point pressure sensor at the anode inlet or the anode outlet and the second single point pressure sensor at the cathode inlet or the cathode outlet to determine a calibration value and communicating the calibration value to the one or more controllers of the proportional control valve. The method may further include updating the calibration value to determine an updated calibration value and communicating the updated calibration value to one or more controllers of the proportional control valve.

In the second aspect of the present invention, the method may further include introducing a disturbance using the proportional control valve based on operating condition of the fuel cell or fuel cell stack.

In the second aspect of the present invention, the method may further include evaluating the first single point pressure sensor and the second single point pressure sensor relative to each other and introducing a correction into the proportional control valve if required.

In the second aspect of the present invention, measuring the first pressure differential may include using a pressure differential sensor determining the pressure differential measured across the anode and the cathode.

In the second aspect of the present invention, the first and second single point pressure sensors may have a combined standard error less than about 25% of a target bias pressure.

In the second aspect of the present invention, the method may further include identifying a target pressure difference based on operating conditions of the fuel cell or fuel cell stack.

In the second aspect of the present invention, controlling the proportional control valve may further include implementing an inner control loop. The inner control loop may be an open loop based on pressure downstream of the proportional control valve. The method may further including implementing the inner control loop by estimating a target fuel flow rate. The inner control loop may use a force balance or inverse sympathetic ratio (ISR) compensation method. The inner control loop may compensate for a fuel supply temperature measurement by using a physical or virtual sensor.

In the second aspect of the present invention, the control valve may be configured to operate in combination with an ejector. The method may further include correcting for non-linear dynamics when a primary nozzle of the ejector is choked or not choked. Correcting for non-linear dynamics may be implemented by the one or more controllers.

In the second aspect of the present invention, the method may further include the one or more controllers of the proportional control valve targeting a bias pressure with an offset. The offset may be calibrated based on a known uncertainty of the first and second single point pressure sensors and on a minimum target bias pressure.

The features illustrated or described in connection with one exemplary embodiment or aspect may be combined with any other feature or element of any other embodiment or aspect described herein. Such modifications and variations are intended to be included within the scope of the present disclosure. Further, a person skilled in the art will recognize that terms commonly known to those skilled in the art may be used interchangeably herein.

The above embodiments and aspects are described in sufficient detail to enable those skilled in the art to practice what is claimed and it is to be understood that other embodiments may be utilized and that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated.

Furthermore, references to “one embodiment” of the presently described subject matter are not intended to be interpreted as excluding the existence of additional embodiments that also incorporate the recited features. Specified numerical ranges of units, measurements, and/or values include, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first”, “second”, “third”, and the like, as used herein do not denote any order or importance, but rather are used to distinguish one element from another. The term “or” and “and/or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising”, “including”, or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps. The phrase “consisting of” or “consists of” refers to a compound, composition, formulation, or method that excludes the presence of any additional elements, components, or method steps.

The term “consisting of” also refers to a compound, composition, formulation, or method of the present disclosure that excludes the presence of any additional elements, components, or method steps. The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell stack system, comprising:
a fuel cell stack including:
an anode with an anode inlet and an anode outlet, and
a cathode with a cathode inlet and a cathode outlet, and
a proportional control valve controlling the flow of a fuel into the anode based on a pressure differential measured across any two of the anode inlet, the anode outlet, the cathode inlet, and the cathode outlet.

2. The fuel cell stack system of claim 1, wherein the pressure differential is measured by a first single point pressure sensor positioned at the anode inlet or the anode outlet and a second single point pressure sensor positioned at the cathode inlet or the cathode outlet.

3. The fuel cell stack system of claim 1, wherein the first pressure differential is measured by a pressure differential sensor across the anode and the cathode.

4. The fuel cell stack system of claim 1, wherein the proportional control valve is configured to operate in combination with an ejector.

5. The fuel cell stack system claim 4, wherein the proportional control valve comprises at least one controller that corrects for non-linear dynamics when a primary nozzle of the ejector is choked or not choked.

6. The fuel cell stack system of claim 2, wherein measurements made by the first single point pressure sensor at the anode inlet or anode outlet and the second single point pressure sensor at the cathode inlet or cathode outlet have a combined standard error of less than about 25% of a target bias pressure, wherein the target bias pressure is based on operating conditions of the fuel cell stack.

7. The fuel cell stack system of claim 2, wherein the first single point pressure sensor at the anode inlet or anode outlet and the second single point pressure sensor at the cathode inlet or cathode outlet are subject to a calibration.

8. The fuel cell stack system of claim 7, wherein the calibration is communicated to a controller of the proportional control valve.

9. The fuel cell stack system of claim 2, wherein a controller of the proportional control valve targets a bias pressure with an offset, and wherein the offset is calibrated based on a known uncertainty in measurements made by the first and second single point pressure sensors, and on a minimum target bias pressure.

10. The fuel cell stack system of claim 9, wherein the controller of the proportional control comprises an inner control loop and an outer control loop.

11. The fuel cell stack system of claim 10, wherein the inner control loop is an open loop based on pressure downstream of the proportional control valve and is estimated using a target flow rate.

12. The fuel cell stack system of claim 11, wherein the inner control loop uses a force balance or inverse sympathetic ratio (ISR) compensation method.

13. The fuel cell stack system of claim 12, wherein the inner control loop compensates for a fuel supply temperature by using a physical or virtual sensor.

14. A method of implementing and/or controlling a proportional control valve in a fuel cell or fuel cell stack, comprising:
measuring a pressure differential across any two of an anode inlet, an anode outlet, a cathode inlet, and a cathode outlet of the fuel cell stack,
flowing a fuel through a proportional control valve based on the pressure differential, and
controlling the proportional control valve operation by one or more controllers,
wherein an anode includes the anode inlet and the anode outer, and a cathode includes the cathode inlet and the cathode outlet.

15. The method of claim 14, wherein measuring the pressure differential comprises using a first single point pressure sensor at the anode inlet or the anode outlet and a second single point pressure sensor at the cathode inlet or the cathode outlet.

16. The method of claim 14, wherein measuring the first pressure differential comprises using a pressure differential sensor determining the pressure differential measured across the anode and the cathode.

17. The method of claim 15, wherein the first and second single point pressure sensors have a combined standard errors less than about 25% of a target bias pressure.

18. The method of claim 15, wherein the method further comprises calibrating offline the first single point pressure sensor at the anode inlet or the anode outlet and the second single point pressure sensor at the cathode inlet or the cathode outlet to determine a calibration value and communicating the calibration value to the one or more controllers of the proportional control valve.

19. The method of claim 18, wherein the method further comprises updating the calibration value to determine an updated calibration value and communicating the updated calibration value to the one or more controllers of the proportional control valve.

20. The method of claim 18, wherein the method further comprises introducing a disturbance using the proportional control valve based on operating condition of the fuel cell or fuel cell stack.
